(19) United States
(12) Patent Application Publication
(10) Pub. No.: US 2016/0211797 A1
(43) Pub. Date: Jul. 21, 2016

(54) PHOTOVOLTAIC POWER GENERATION SYSTEM AND SHUT-DOWN DEVICE

(71) Applicant: DELTA ELECTRONICS, INC., Taoyuan Hsien (CN)

(72) Inventors: Xuancai ZHU, Taoyuan Hsien (CN); Bingwen WENG, Taoyuan Hsien (CN); Yanlong LI, Taoyuan Hsien (CN)

(21) Appl. No.: 14/823,603

(22) Filed: Aug. 11, 2015

(30) Foreign Application Priority Data
Jan. 16, 2015 (CN) 201510023147.7

(51) Int. Cl. H02S 40/32; H02S 40/34

(52) U.S. Cl. CPC H02S 40/32; H02S 40/34

(57) ABSTRACT

The present disclosure provides a photovoltaic power generation system and a shut-down device. The photovoltaic power generation system comprises: a photovoltaic array, an inverter, and a shut-down device electrically connected between the photovoltaic array and the inverter, wherein the inverter generates a first control signal when the inverter is turned off or fails; and the shut-down device receives the first control signal, to disconnect the photovoltaic array from the inverter. The photovoltaic power generation system according to the present disclosure has higher safety and reliability.

### CROSS REFERENCE TO RELATED APPLICATIONS

The present application claims priority under 35 U.S.C. §119 to Chinese Patent Application No. 201510023147.7, filed on Jan. 16, 2015, the entire content of which is incorporated herein by reference.

### TECHNICAL FIELD

The present disclosure relates to safety shut-down technologies, and particularly, relates to a photovoltaic power generation system capable of performing safety power cut-off, and a shut-down device for the photovoltaic power generation system.

### BACKGROUND

The photovoltaic power generation technology has been matured at present, and has been widely applied in the world. A photovoltaic power generation system includes a photovoltaic array, a terminal box, a photovoltaic inverter, and other devices. The photovoltaic array transforms received solar energy into direct current (DC) electric energy, and the inverter transforms the DC electric energy into desired alternating current (AC) electric energy which is fed into the electric grid or directly supplied to users. A terminal box is provided with a DC switch which may control DC voltage inputs of the inverter.

The photovoltaic array with serial and/or parallel connections may have a high voltage and high energy. Therefore, in case of emergent incidents (earthquakes, fires, or the like), the photovoltaic array having such a high voltage and high energy must be disconnected, in order to prevent the array with the high voltage and high energy from causing even greater disasters, and meanwhile ensure safety of the rescue personnel.

However, the DC switch in the terminal box merely ensures that the inverter has no DC voltage input. In case where the conducting wire from the photovoltaic array to the terminal box is broken and exposed due to such factors as natural disasters, it will pose great difficulty to the rescue work of the rescue personnel, and even safety of the rescue personnel may be threatened. In case of fires, the high-pressure water operated by the rescue personnel may contact with the broken conducting wire with high voltage. Since water is electrically conductive, safety of the rescue personnel may be threatened.

FIG. 1 illustrates a photovoltaic power generation system in the related art. The photovoltaic power generation system includes a photovoltaic array 1, a terminal box 2, and an inverter 3. The photovoltaic array 1 includes a plurality of photovoltaic panels. The photovoltaic panels transform solar energy into electric energy with a low DC voltage, and the desired high voltage may be obtained by connecting in serial and then connecting in parallel the plurality of low voltage photovoltaic panels. The terminal box 2 includes a fuse 21, a connecting terminal 22, and a DC switch 23. The fuse 21 protects the photovoltaic panels and prevents fire caused by a short circuit at input. The terminal box 2 may connect the photovoltaic array 1 with the inverter 3. The DC switch 23 may disconnect the photovoltaic array 1 from the inverter 3.

The above information disclosed in the background portion is only for better understanding of the background of the present disclosure. Therefore, the above information may include information not construing the known related art for persons of ordinary skill in the art.

### SUMMARY OF THE INVENTION

According to one aspect of the present disclosure, a photovoltaic power generation system is provided. The photovoltaic power generation system includes: a photovoltaic array, an inverter, and a shut-down device electrically connected between the photovoltaic array and the inverter; wherein: the inverter generates a first control signal when the inverter is turned off or fails; and the shut-down device receives the first control signal, to disconnect at least an electrical connection between the photovoltaic array and the inverter.

According to another aspect of the present disclosure, a shut-down device for a photovoltaic power generation system is provided. The photovoltaic power generation system includes: a photovoltaic array and an inverter; and the shut-down device is electrically connected between the photovoltaic array and the inverter. The inverter generates a first control signal when the inverter is turned off; and the shut-down device receives the first control signal, to disconnect at least an electrical connection between the photovoltaic array and the inverter.

According to another aspect of the present disclosure, a photovoltaic power generation system is provided. The photovoltaic power generation system includes: a photovoltaic array, an inverter, a terminal box, and a shut-down device electrically connected between the photovoltaic array and the terminal box; wherein: the inverter or the terminal box generates a first control signal; and the shut-down device receives the first control signal, to disconnect at least an electrical connection between the photovoltaic array and the inverter.

### BRIEF DESCRIPTION OF THE DRAWINGS

The above and other features and advantages of the present disclosure will be more apparent for a person skilled in the art upon reading the following detailed description of exemplary embodiments illustrated in the accompany drawings.

FIG. 1 is a schematic diagram of a photovoltaic power generation system in the related art;

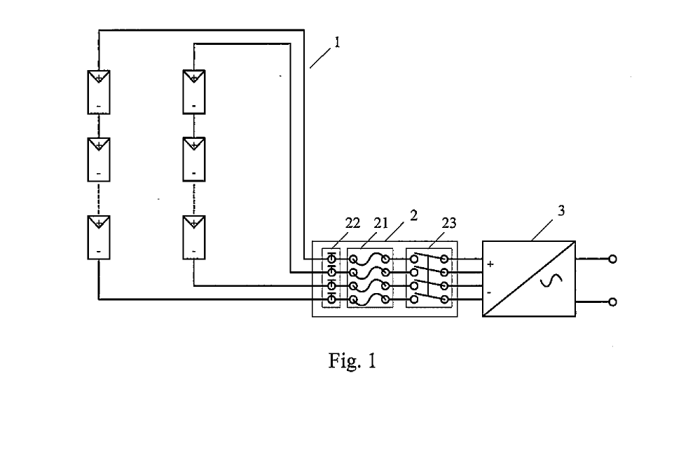

FIG. 2 is a schematic diagram of a photovoltaic power generation system according to an exemplary embodiment of the present disclosure; and

FIG. 3 is a schematic diagram of a shut-down device according to an exemplary embodiment of the present disclosure.

### DETAILED DESCRIPTION OF THE INVENTION

Exemplary embodiments of the present disclosure are hereinafter described in detail with reference to accompany drawings. However, the exemplary embodiments may be implemented in a plurality of forms, and shall not be construed as being limited to the implementation described hereinafter. On the contrary, the exemplary embodiments are provided to make the present disclosure more thorough and complete, and convey the concepts of the exemplary embodiments to persons skilled in the art. In the drawings, like reference numerals denote like or similar structures or elements. Therefore, redundant descriptions of these structures or elements are not given repeatedly.

In addition, the described characteristics, structures, or features may be incorporated in one or more embodiments in any suitable manner. In the description hereinafter, more details are provided such that sufficient understanding of the embodiments of the present disclosure may be achieved. However, a person skilled in the art would appreciate that the technical solutions of the present disclosure may be practiced without one or more of the specific details. Under other circumstances, known structures, materials or operations are not illustrated or described in detail to avoid obscuring of the various aspects of the present disclosure

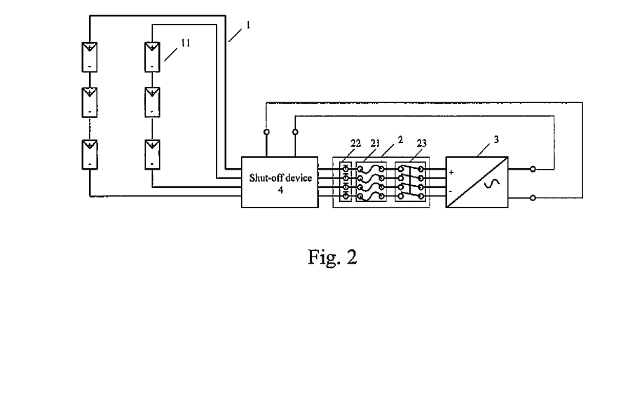

FIG. 2 is a schematic diagram of a photovoltaic power generation system according to an exemplary embodiment of the present disclosure.

As illustrated in FIG. 2, the photovoltaic power generation system may include a photovoltaic array 1, a terminal box 2, an inverter 3, and a shut-down device 4. The shut-down device 4 is electrically connected between the photovoltaic array 1 and the inverter 3. The terminal box 2 may be electrically connected between the inverter 3 and the shut-down device 4. In an exemplary embodiment, the terminal box 2 may be omitted in the photovoltaic power generation system.

The photovoltaic array 1 may include, for example, at least one group of photovoltaic array units 11 which may be connected in parallel to each other; wherein each group of the photovoltaic array units 11 may include a plurality of photovoltaic panels which may be connected in serial to each other.

The inverter 3 may be electrically connected, for example, in serial, to the shut-down device 4 through the terminal box 2.

The terminal box 2 may include: for example, a connecting terminal 22, a fuse 21, and a DC switch 23. The connecting terminal 22 may be coupled to the shut-down device 4. The terminal box 2 is connected between the photovoltaic array 1 and the inverter 3. The DC switch 23 is connected to the inverter 3, and the fuse 21 may be connected between the connecting terminal 22 and the DC switch 23. However, the present disclosure is not limited thereto, and may cover various relative positions of these components as long as functionality thereof may be implemented.

The fuse 21 is configured to protect the photovoltaic array 1, so as to prevent serious problems due to a short circuit at input. For example, when the photovoltaic array 1 or the inverter 3 is short-circuited, the current output from the photovoltaic array 1 is greater than a rated current of the fuse 21, and the fuse 21 is fused, or the fuse 21 is deformed, such that the electrical connection between the photovoltaic array 1 and the inverter 3 is disconnected. The fuse 21 may be, for example, a thermal fuse. However, the present disclosure is not limited thereto.

The DC switch 23 may disconnect or connect the photovoltaic array 1 from or with the inverter 3. When the DC switch 23 is closed, the electric energy generated by the photovoltaic array 1 is input to the inverter 3 via the DC switch 23. When the DC switch 23 is opened, the electric energy generated by the photovoltaic array 1 fails to be input to the inverter 3 via the DC switch 23; specifically, in this case, the inverter 3 does not have a DC voltage input. The DC switch 23 may be, for example, a relay or a semiconductor switch. However, the present disclosure is not limited thereto.

The inverter 3 may receive the DC electric energy output by the photovoltaic array 1 and transform the DC electric energy into desired AC electric energy which is fed into the electric grid or directly supplied to users.

According to an exemplary embodiment of the present disclosure, when the output of the inverter 3 is cut off, or when the inverter 3 is turned off, the inverter 3 generates a first control signal. However, the present disclosure is not limited thereto. In an embodiment of the present disclosure, the inverter 3 may also generate the first control signal when the inverter 3 fails, for example, when output of the inverter 3 is short-circuited. In the embodiment of the present disclosure, the first control signal may be a low level signal or a zero level signal. However, the present disclosure is not limited thereto.

After the photovoltaic array 1 generates electric energy, and the inverter 3 is normally connected to the electric grid, the inverter 3 may generate a second control signal. In this embodiment, the second control signal may be a high level signal. However, the present disclosure is not limited thereto. The shut-down device 4 is electrically connected to the photovoltaic array 1, and can be arranged approximate to the photovoltaic array 1. In some embodiments, a distance between the shut-down device 4 and the photovoltaic array 1 is no greater than 1, 3, 5, or 10 meters. However, the present disclosure is not limited thereto. The shut-down device 4 may be arranged approximate to the photovoltaic array 1 and relatively far away from the inverter 3, whereby the safety of the photovoltaic power generation system may be improved.

As illustrated in FIG. 2, for example, the shut-down device 4 may be connected to the inverter 3 via a circuit or wirelessly, so as to receive the first control signal and/or the second control signal of the inverter 3.

The shut-down device 4 may disconnect an electrical connection between the inverter 3 and the photovoltaic array 1 according to the first control signal. The shut-down device 4 may also resume the electrical connection between the inverter 3 and the photovoltaic array 1 according to the second control signal, to enable the inverter 3 to operate normally and to output electric energy to the electric grid or directly supply electric energy to users.

For example, the rescue personnel cut off the output of the inverter 3 when a natural disaster occurs, such that the output of the inverter 3 is no longer with high voltage and high energy which threaten safety of the rescue personnel. However, the high voltage output from the photovoltaic array 1 may be still threatening.

According to the embodiments of the present disclosure, after the output of the inverter 3 being turned off, the inverter 3 may send the first control signal to the shut-down device 4, such that the photovoltaic array 1 is disconnected from the inverter 3. As such, because of the shut-down operation performed by the shut-down device 4, the conducting wire between the output terminal of the shut-down device 4 and the input terminal of the inverter 3 presents no high-voltage and high-powered electric energy. In this way, safety of the rescue personnel may not be threatened. In addition, the shut-down device 4 according to the embodiments of the present disclosure may automatically perform the shut-down operation according to the first control signal, achieving a high shut-down speed. In a specific embodiment, the shut-down device 4 may perform a shut-down operation at a speed of a millisecond level.

After the output of the inverter 3 is normally connected to, for example, the electric grid, the inverter 3 may generate a second control signal. The shut-down device 4 receives the second control signal, such that the inverter 3 is electrically connected with the photovoltaic array 1. In this case, the inverter 3 operates normally, transforms the DC electric energy output by the photovoltaic array 1 into desired AC electric energy, and outputs the AC electric energy to the electric grid or directly supplies the AC electric energy to users.

In a specific embodiment, the above first control signal and the second control signal may also be generated by the terminal box 2 to control the turn-on and turn-off of the shut-down device 4. In a specific embodiment, the inverter 3 may include the terminal box 2.

In an embodiment, for example, the first control signal may be generated when the DC switch 23 of the terminal box 2 is disconnected. In another embodiment, the first control signal may also be generated when the fuse 21 of the terminal box 2 is burned out. The shut-down device 4 disconnects the electrical connection between the terminal box 2 and the photovoltaic array 1 according to the first control signal. The first control signal may be a low level signal. However, the present disclosure is not limited thereto.

In an embodiment, for example, the second control signal may be generated when the DC switch 23 of the terminal box 2 is connected. The shut-down device 4 enables an electrical connection between the terminal box 2 and the photovoltaic array 1 according to the second control signal. The second control signal may be a high level signal. However, the present disclosure is not limited thereto.

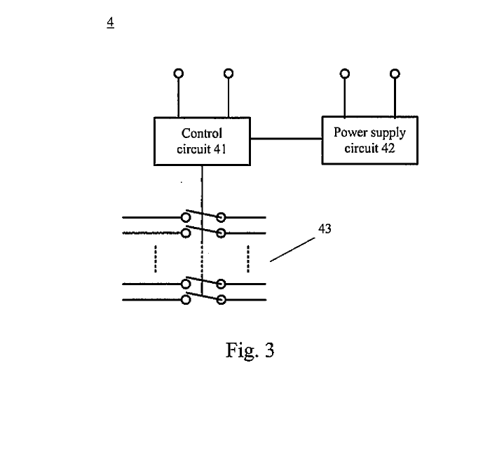

FIG. 3 is a schematic diagram of a shut-down device according to an exemplary embodiment of the present disclosure. As illustrated in FIG. 3, the shut-down device 4 includes a control circuit 41, a switch device 42, and a power supply circuit 43.

The control circuit 41 receives the first control signal and the second control signal to correspondingly control the turn-on and turn-off of the switch device 42.

The switch device 42 may include at least one group of switches, wherein each group of switches may be respectively electrically connected to a corresponding group of photovoltaic array units 11. In a specific embodiment, the switches are relays or semiconductor switches. However, the present disclosure is not limited thereto.

According to an exemplary embodiment of the present disclosure, the shut-down device 4 may be supplied power by the photovoltaic array 1. For example, the power supply circuit 43 is electrically connected to the photovoltaic array 1 to receive electric energy from the photovoltaic array 1, and transfer the electric energy to the control circuit 41 and the switch device 42, to supply power to the control circuit 41 and the switch device 42. In a specific embodiment, the power supply circuit 43 of the shut-down device 4 may further include a power converter, wherein the power converter is configured to transform the electric energy of the photovoltaic array 1 into electric energy possibly required by the control circuit 41 and the switch device 42.

Described above are exemplary embodiments of the present disclosure. However, these embodiments are not intended to limit the present disclosure. A person skilled in the art may make variations to the technical features of the present disclosure based on the content expressly or implicitly disclosed in the present disclosure. All such variations may fall within the protection scope of the present disclosure. In other words, the protection scope of the present disclosure is defined by the appended claims.

What is claimed is:

1. A photovoltaic power generation system, comprising:
a photovoltaic array,
an inverter, and
a shut-down device electrically connected between the photovoltaic array and the inverter;
wherein, the inverter generates a first control signal when the inverter is turned off or fails; and
the shut-down device receives the first control signal, to disconnect at least an electrical connection between the photovoltaic array and the inverter.

2. The photovoltaic power generation system according to claim 1, wherein the photovoltaic power generation system further comprises a terminal box, wherein the terminal box is electrically connected between the inverter and the shut-down device.

3. The photovoltaic power generation system according to claim 2, wherein the terminal box comprises: a fuse, a DC switch, and a connecting terminal connecting the fuse and the DC switch; wherein the fuse is connected to the shut-down device, and the DC switch is connected to the inverter.

4. The photovoltaic power generation system according to claim 1, wherein the shut-down device comprises: a switch device and a control circuit; wherein the control circuit receives the first control signal to control the switch device.

5. The photovoltaic power generation system according to claim 4, wherein the shut-down device further comprises a power supply circuit, wherein the power supply circuit is electrically connected to the photovoltaic array.

6. The photovoltaic power generation system according to claim 4, wherein the switch device comprises a plurality of groups of switches, and the photovoltaic array comprises a plurality of groups of photovoltaic array units; wherein each group of the switches is respectively electrically connected to a corresponding group of the photovoltaic array units.

7. The photovoltaic power generation system according to claim 4, wherein the switch device comprises at least one group of switches, wherein the switches are relays or semiconductor switches.

8. The photovoltaic power generation system according to claim 1, wherein a distance is provided between the shut-down device and the photovoltaic array, wherein the distance is no greater than 3 meters.

9. A shut-down device for a photovoltaic power generation system, the photovoltaic power generation system comprising:
a photovoltaic array, and
an inverter, the shut-down device being electrically connected between the photovoltaic array and the inverter;
wherein:
the inverter generates a first control signal when the inverter is turned off or fails; and
the shut-down device receives the first control signal, to disconnect at least an electrical connection between the photovoltaic array and the inverter.

10. The shut-down device according to claim 9, wherein the shut-down device comprises a switch device and a control circuit; wherein the control circuit receives the first control signal to control the switch device.

11. The shut-down device according to claim 9, wherein the shut-down device further comprises a power supply circuit, wherein the power supply circuit is electrically connected to the photovoltaic array.

12. The shut-down device according to claim 9, wherein a distance is provided between the shut-down device and the photovoltaic array, and the distance is no greater than 3 meters.

13. A photovoltaic power generation system, comprising:
a photovoltaic array,
an inverter,
a terminal box, and
a shut-down device electrically connected between the photovoltaic array and the terminal box;
wherein, the inverter or the terminal box generates a first control signal; and
the shut-down device receives the first control signal, to disconnect at least an electrical connection between the photovoltaic array and the inverter.
